(19) United States
(12) Patent Application Publication
(10) Pub. No.: US 2010/0280665 A1
(43) Pub. Date: Nov. 4, 2010

(54) SENSOR AND BOILER CONTROL SYSTEM

(75) Inventors: Christopher Fildes, Elyria, OH (US); John Bohan, Avon Lake, OH (US); Timothy Beight, Amherst, OH (US)

Correspondence Address: ESCHWEILER & ASSOCIATES, LLC;NATIONAL CITY BANK BUILDING, 629 EUCLID AVE., SUITE 1000, CLEVELAND, OH, 44114, US

(73) Assignee: R. W. Beckett Corporation, North Ridgeville, OH (US)

(21) Appl. No.: 12/435,238

(22) Filed: May 4, 2009

(51) Int. Cl. G05B 15/00; F24H 9/20

(52) U.S. Cl. 700/275; 122/14.21

(57) ABSTRACT

A system and method is presented for a boiler controller for a boiler system. The boiler controller comprises a sensor monitoring component, operably coupled to a temperature detector operable to measure a temperature of a medium within the boiler, and a pressure detector operable to measure a pressure of the medium. The boiler controller also comprises a burner controller coupled to a burner. The burner controller is operable to control the burner to heat the boiler based upon at least one of the temperature of the medium measured by the temperature detector compared to a range of temperature setpoints, results of an energy efficiency calculation, a presence of the medium, and the pressure of the medium.

### FIELD OF INVENTION

The present invention relates generally to sensors and more particularly to sensor and boiler controls, and communication protocols of a boiler controller used in a boiler system, the boiler controller used in detecting and controlling various medium conditions associated with the boiler system.

### BACKGROUND OF THE INVENTION

Boiler and heating systems employ various methods to control the temperature of components within the system. The temperatures of these components are usually regulated within a particular range in order to maintain safe operation. Two such components that require regulation are heat exchangers of furnaces and the water inside a pressurized hot water boiler.

Conventionally, multiple boiler control components may be utilized, for example, to monitor a temperature of the medium within the boiler and/or within zones associated with the boiler, or to monitor a thermostat, and a presence of water in the boiler. The boiler controller or the multiple boiler control components may then use this information to control a burner that heats the boiler and a circulator pump that distributes the water throughout the heated zones.

However, current boiler control systems tend to be inefficient using more energy or fuel than may be required. For example, these boiler control systems may not compensate system operations utilizing valuable information such as the outside air temperature. In addition, present boiler control systems may not provide system safety or alarm information valuable to the user or other such information necessary to maintain continued system operations or to avoid an impending system failure.

Heating applications sensors may include temperature, pressure, flow, and medium presence sensors, and others such as may be used in furnaces and boilers. The exposed portion of the sensor is often the hottest portion of the measurement circuit and may therefore be exposed to the harshest conditions. These HVAC sensors are also exposed to processes that may increase the likelihood of changes in the electrical properties of the sensor or cause a complete system failure.

In boiler applications, for example, temperature, pressure, flow, and medium presence detection may be used, wherein the failure of a temperature sensor or an associated low-water level cutoff detector may cause a boiler malfunction or failure. Thus, the failure of such boiler sensors poses a problem. Accordingly, a boiler controller or control system that supports a fail-safe temperature sensor, and/or a fail-safe low-water level cut-off detector and/or a pressure sensor would be desirable to avoid such problems.

For design, manufacturing, and applications reasons, the HVAC sensors discussed above are generally individually fabricated, packaged and mounted with associated controllers. However, the use of these numerous individual sensors/controllers also requires more system mounting difficulties, additional wiring and added complexity in support of the remaining portion of the control system. Such additional support components and circuitry may include related relays, power supplies, and microprocessors that increase the overall cost and complexity of the system.

In many applications, however, several specific sensors are commonly used together with a controller. For example, in the case of boiler heating systems, a boiler water temperature sensor is usually accompanied by a low-water cutoff detector, which senses the presence of the water (or another such medium) when strategically placed at the low water level of the boiler. If the water falls below this level, the system is typically shut-down until more water is added, thereby immersing the sensor again. In addition, pressure relief valves are usually included in boiler systems to relieve over-pressure conditions such as in the event the boiler overheats producing steam and an excessive pressure build-up. A pressure sensor would be useful to monitor for such failsafe conditions, particularly if the water falls below the low water level.

Accordingly, to accommodate energy efficiency, cost, fail-safe readings and operations, mounting and system simplicity goals, there is a need for a boiler control system that incorporates medium temperature, pressure and presence detection functions as well as other associated system detection and control capabilities in a boiler controller.

### SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present some concepts of the invention in a simplified form as a prelude to the more detailed description that is presented later.

The present invention is directed to a boiler controller for a boiler, comprising a sensor monitoring component, adapted to be coupled to a temperature detector operable to measure a temperature of a medium within the boiler, and a pressure detector operable to measure a pressure of the medium. The boiler controller also comprises a burner controller configured to provide one or more control signals to a burner. The burner controller is operable to control the burner to heat the boiler based upon at least one of the temperature of the medium measured by the temperature detector as compared to a range of temperature setpoints, energy efficiency calculations using data from the temperature of the medium or a system duty cycle, a presence of the medium, and the pressure of the medium.

In another embodiment of the present invention, a boiler controller for a boiler comprises a sensor monitoring component adapted to be coupled to a temperature detector operable to measure a temperature of a medium within the boiler, a presence detector operable to detect the presence of the medium, and a pressure detector operable to measure a pressure of the medium, and one or more of an outdoor temperature detector operable to measure an outdoor air temperature associated with the boiler, a tank level detector operable to measure a fuel tank level associated with a burner used with the boiler, and a thermostat located within a zone heated by the boiler, the thermostat operable to provide one of a temperature indication or a call for heat associated with the heated zone. The boiler controller further comprises a burner controller configured to provide one or more control signals to a burner and operable to control the burner to heat the boiler. The burner controller controls the burner based upon at least one of: the temperature of the medium measured by the temperature detector as compared to a range of temperature setpoints, energy efficiency calculations using data from one or more of the temperature of the medium, a system duty cycle, the outdoor air temperature and the thermostat temperature indication, and at least one of the presence of the medium, pressure of the medium and the fuel tank level.

In one aspect of the present invention, a method is disclosed for a method of controlling a boiler to regulate a temperature within the boiler and in a zone heated by the boiler, to limit a pressure and maintain a presence of a medium within the boiler using a boiler controller. The method comprises receiving a temperature of the medium within the boiler, determining whether to heat the boiler, and enabling a heat signal for heating the boiler until the temperature of the medium within the boiler is above a high limit temperature setpoint, and generating a circulation signal for circulating the heated medium through the zone if the zone issues a call for heat to the boiler controller. The method further comprises enabling the heat signal for heating the boiler until the zone stops calling for heat from the boiler controller, generating a circulation signal for circulating the heated medium through the zone if a pump inactivity timer expires in the boiler controller, generating a circulation signal for circulating the heated medium until a pump exercise timer times out, and generating a circulation signal for circulating the heated medium through the zone until the zone stops calling for heat from the boiler controller and a circulator off-delay timer times out. The method also comprises energizing a zone if the temperature of the medium within the boiler is above a low limit temperature setpoint, and receiving a pressure of the medium within the boiler and determining whether a high pressure condition exists.

In another embodiment, the economizer algorithm is further configured and operable to monitor an outdoor temperature detector operable to measure an outdoor air temperature associated with the boiler, and revise the energy efficiency calculations used to reestablish a boiler set-point temperature therefrom.

In another implementation of the present invention, the economizer algorithm is further configured and operable to find a lowest boiler set-point temperature that will allow the boiler to meet the range of temperature setpoints.

Thus, in one embodiment, the boiler controller saves energy/fuel by seeking the lowest boiler set-point temperature and eliminates the need for additional and relatively costly medium presence detection (e.g., low-water cutoff) devices and controls (e.g., related relays, power supplies, and microprocessors) currently used in conventional boiler/HVAC systems.

In yet another aspect of the invention, the burner controller is configured to be disabled or to disable the burner when an overpressure of the boiler is detected using the pressure measured by a pressure detector.

In one aspect, the boiler controller further comprises an RF transceiver for wirelessly communicating with one or more or a combination of a zone air temperature located within a zone heated by the boiler, the zone air temperature operable to provide a temperature indication associated with the heated zone, a hot water heater temperature associated with a hot water heater, a thermostat located within the zone heated by the boiler, the thermostat operable to provide a temperature indication associated with the heated zone, an outdoor temperature detector operable to measure an outdoor air temperature associated with the boiler, and a tank level detector operable to measure a fuel level of a fuel in a fuel tank associated with the boiler.

In another implementation of the present invention, the boiler controller further comprises a user interface comprising a display configured to display alphanumeric characters, representing one or more temperature and pressure measurements, and temperature set points associated with the boiler, and a plurality of pushbuttons for inputting and changing the set points, for selecting one or more operational modes of the boiler controller, and for configuring one or more options of the boiler controller.

In another embodiment, the boiler controller is configured and operable to digitally communicate with one or more or a combination of wired and wireless accessory modules, such as an RF transceiver, a router, a remote display, a low-water cut-off alarm, a lockout alarm, an outdoor temperature sensor, a fuel tank level sensor, a POTs modem, a zone temperature sensor, and a thermostat.

In yet another embodiment, the boiler controller is configured and operable to receive one or more initial parametric inputs provided by the manufacturer comprising one or more of a low limit and high limit temperature setpoint, a low limit and high limit temperature differential, a low limit and high limit pressure setpoint, a circulation pump exercise time, a circulation pump inactivity time, a circulation pump off delay time, a circulation pump on delay time, a line voltage minimum and maximum, a boiler set-point temperature, a sensor and controller model number, a sensor and controller serial number, a manufacturing date, a calibration temperature and a calibration pressure.

To the accomplishment of the foregoing and related ends, the following description and annexed drawings set forth in detail certain illustrative aspects and implementations of the invention. These are indicative of but a few of the various ways in which the principles of the invention may be employed. Other aspects, advantages and novel features of the invention will become apparent from the following detailed description of the invention when considered in conjunction with the drawings.

### BRIEF DESCRIPTION OF THE DRAWINGS

FIG. 1 is a simplified diagram of a prior art hot water boiler system using separate conventional medium temperature, pressure and presence detecting sensors and controllers for monitoring and controlling the various parameters of the boiler;

FIGS. 2A and 2B illustrate isometric diagrams of an exemplary boiler controller together with an exemplary multi-sensor component such as is illustrated separately in FIG. 2C, the exemplary boiler controller used in accordance with an aspect of the present invention to monitor one or more of a temperature, a pressure and a presence of a medium in a boiler, and further operable to control a burner and a circulation pump associated with the boiler system similar to that of FIG. 1;

FIG. 2D illustrates a simplified diagram of an exemplary boiler control system comprising a boiler controller such as that of the boiler controller of FIGS. 2A-2B used in accordance with an aspect of the present invention, the boiler control system comprising a temperature detector, a pressure detector, a thermostat or temperature sensor, an outdoor temperature sensor, a fuel tank level sensor, an accessory port, a user interface, a burner and a circulation pump;

FIG. 3 is a simplified diagram of an exemplary hot water boiler system using a single boiler controller and associated multi-sensor component for measuring a temperature and pressure of the water and for detecting the presence of the water in the boiler, the functions provided together in a single boiler controller and fail-safe multi-sensor component;

FIG. 4 is a simplified block diagram of an equivalent circuit of an exemplary multi-sensor component of the present invention such as may be used in the boiler control system of FIGS. 2A, 2B and 2D and 3 for monitoring the temperature, pressure and presence of an object or medium, and for controlling the boiler system such as that of FIG. 3 in accordance with an aspect of the present invention;

FIG. 5 is a simplified plot of exemplary hot water setpoints vs. exemplary outdoor air temperatures for an exemplary outdoor air temperature sensor, such as may be used to establish temperature setpoints for the boiler controller of FIGS. 2A, 2B and 2D in accordance with another aspect of the present invention;

FIG. 6A is a functional state diagram of a control algorithm for an exemplary boiler control system, the control algorithm used for monitoring and analyzing medium temperatures, medium pressure and presence, for controlling the burner and circulation pump of a boiler system, for testing controller component or system failures, and for monitoring and calculating energy efficiencies in a fail-safe manner in accordance with an aspect of the present invention;

FIG. 6B is a flow diagram illustrating a method of economizing utilizing an economizer algorithm comprising monitoring the medium and outdoor air temperatures and calculating a lowest practical boiler set-point temperature that will allow the boiler to meet a range of setpoints and/or the thermostat and zone temperature setpoints in accordance with one or more aspects of the present invention; and

FIG. 7 is a simplified exemplary Beckett system communications diagram, such as may use the boiler controller of FIGS. 2A, 2B and 2D in accordance with the present invention.

### DETAILED DESCRIPTION OF THE INVENTION

The present invention will now be described with reference to the attached drawings, wherein like reference numerals are used to refer to like elements throughout. The invention relates to a boiler control system and a boiler controller and method used for monitoring and controlling, within a single controller housing, various medium conditions associated with a boiler of the boiler system or another such system including a hot water heater in a fail-safe manner. In one embodiment, the boiler controller of the present invention monitors temperature, pressure and presence of medium in the boiler, a thermostat setpoint, an outdoor air temperature, a fuel tank level sensor, communicates with various wired or wireless accessory modules such as an RF wireless transceiver or router, and using data from such sensors, controls the firing of a burner to heat the boiler and controls a circulation pump that distributes the medium throughout one or more zones heated by the medium. The boiler controller also applies the sensor data to an energy savings or economizer algorithm that seeks the lowest practical boiler setpoint temperature based on, for example, one or more of the outside air temperature, a calculated thermostat duty cycle, and a system duty cycle. Further, the exemplary boiler controller also includes a user interface having a display for viewing various boiler status conditions and preset values, and includes pushbuttons for selecting various modes or for entering the preset values.

In one embodiment, to insure failsafe operations, the boiler controller also monitors various boiler controller system components for failures, such as one or more burner relays that control the firing of the burner, the circulation pump, the multi-sensor component comprising temperature, pressure and presence detectors, and a microcontroller used in the boiler controller having a discrete watchdog timer.

In another embodiment, the boiler controller is mounted directly on the multi-sensor component which itself is mounted onto the boiler.

When used in a hot water or steam boiler application, for example, a goal of the boiler controller of the present invention is to combine the sensor monitoring functions of a temperature detector and a low-water cut-off device, and a pressure detector or over-pressure detector and the control functions of a burner controller and an economizing algorithm within a single controller housing. Conventionally, these functions typically require the use of separate devices, which add system complexity as well as cost for the added supporting components (e.g., relays, power supplies, microprocessors, housings, wiring) and for the individual device mounting costs.

The boiler controller communications with the accessory modules may be provided, for example, on a four-wire serial bus.

Initial parameters or calibration data of the specific thermoelements used in the sensor(s) or boiler controller may be supplied by the manufacturer or otherwise ascertained in another manner and used in the algorithm or controller. These parameters may be useful for increasing the accuracy of the temperature measurements, for calibration purposes, or establishing various setpoints. In addition, inputting one or more predetermined acceptable or expected levels of boiler or system thermal decay rate time constants may be useful for identification of specific medium densities, for identification of sensor degradation levels and failure predictions, or to limit the range of set points to match appliance limitations. In order to better appreciate one or more features of the invention, several exemplary implementations of the boiler controller and a temperature, pressure and presence detection system, the boiler control and economizing algorithm method are hereinafter illustrated and described in association with the following figures.

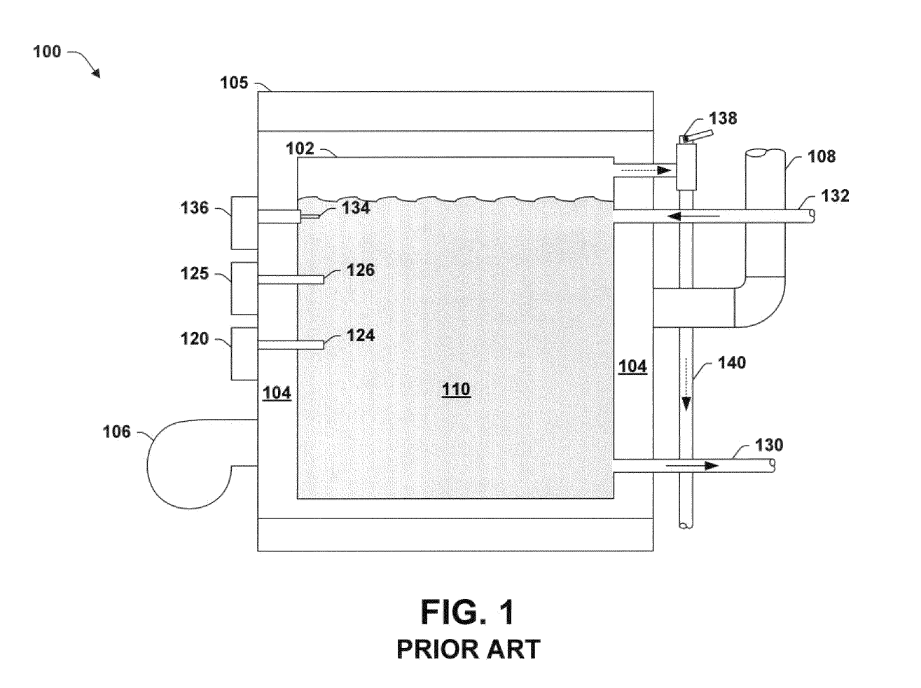

FIG. 1 illustrates a prior art hot water boiler system 100, wherein a conventional temperature sensing controller devices are used for measuring and controlling the boiler based on using separate medium temperature and pressure detecting sensors and controllers for monitoring and controlling the various parameter of the boiler, and a separate conventional low-water cut-off detector and controller used to detect the presence of water in the boiler for safe operation thereof. Numerous types of common temperature and pressure sensing devices or sensors are utilized in such boiler or HVAC systems, including those based on thermocouples, thermistors, and fluid filled copper bulbs to help regulate the temperature and level of water within the boiler.

The conventional boiler 100 of FIG. 1 comprises a boiler tank 102 surrounded by an insulating material layer 104 within a boiler enclosure 105. A burner 106 having a flue vent 108, heats water 110 (or a water/glycol mix) within the tank 102 to a temperature set by a temperature sensing control device 120. The temperature sensing control device 120 has, for example, a fluid filled copper bulb 124, which expands when heated to actuate a high/low limit module for control of the system about a temperature set point. The heated water 110 is circulated through a feed water line 130 out to an external heat exchanger (not shown) and the cooled water returns to the boiler 100 through a supply/return line 132. If the level of the water 110 within the boiler tank 102 drops below the level of a live probe 134 of a low-water cut-off device 136, the burner 106 is shut-down until more water 110 is added to the boiler 100 to maintain safe operation by avoiding boiler damage.

In addition, the boiler 100 may further comprise a water pressure sensor 125 utilizing a pressure sensing bulb or diaphragm 126 operable to sense the pressure of the water 110 within the tank 102. The pressure sensor 125, for example, may then use the detected pressure, to safely control a shut-down of the boiler in the event of an over-pressure condition, and to avoid dumping water through a pressure relief valve 138 and discharge line 140 onto the floor of the boiler room.

Thus, in the conventional boiler system configuration 100, separate water temperature and pressure sensing and water presence detection and associated controllers may be required for operation in a safe manner. Accordingly, added devices, and related equipment costs, including added mounting costs are typically needed in a prior art system.

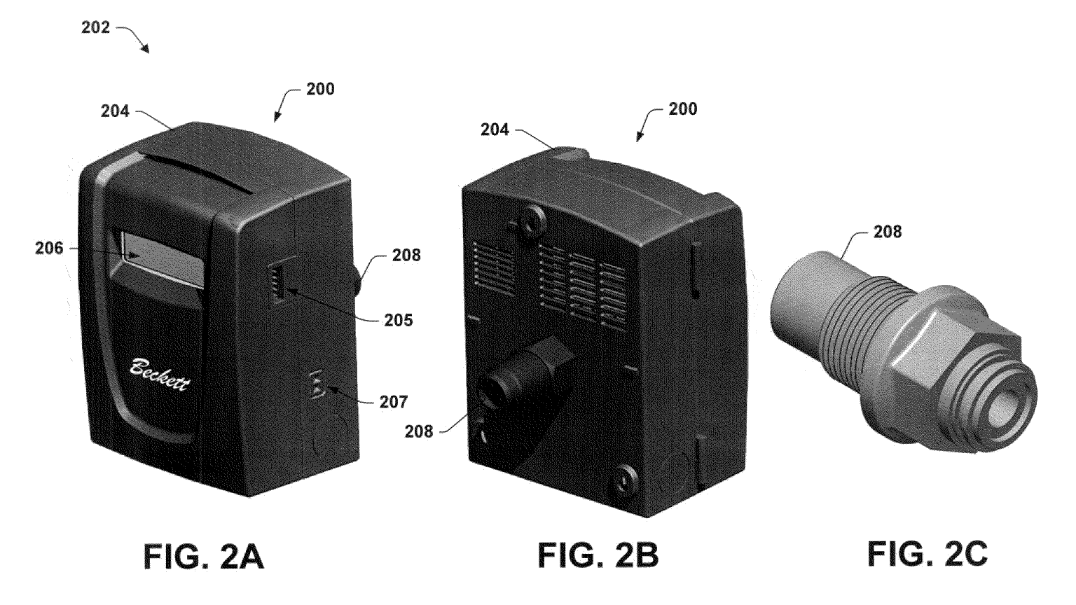

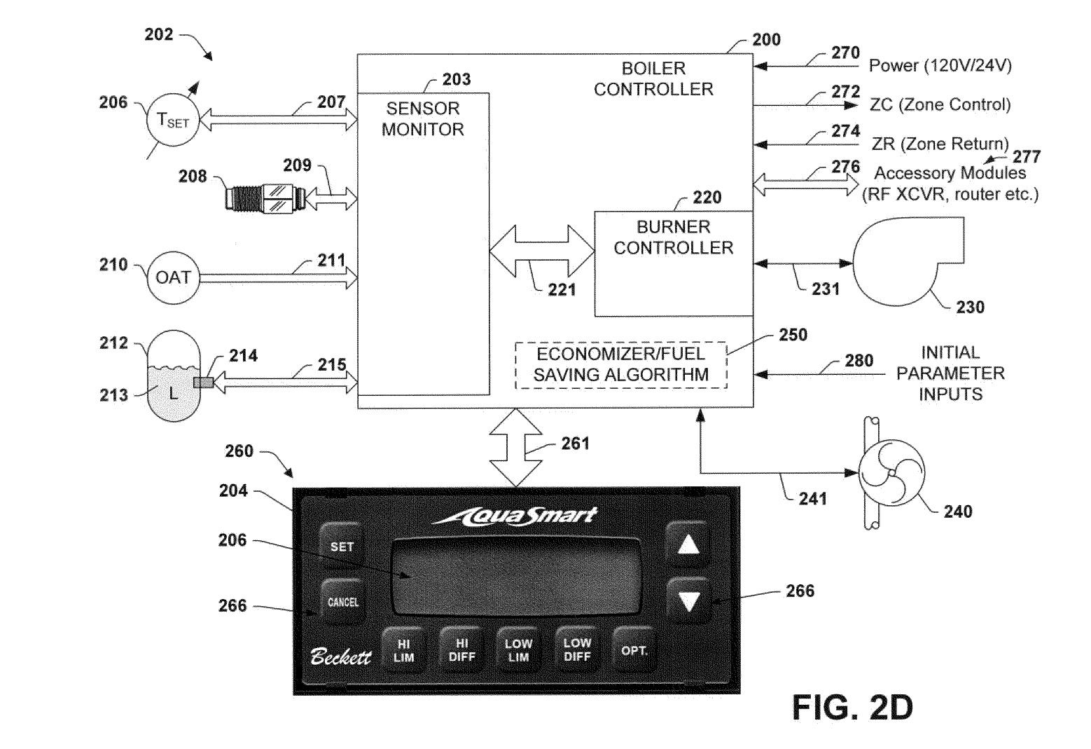

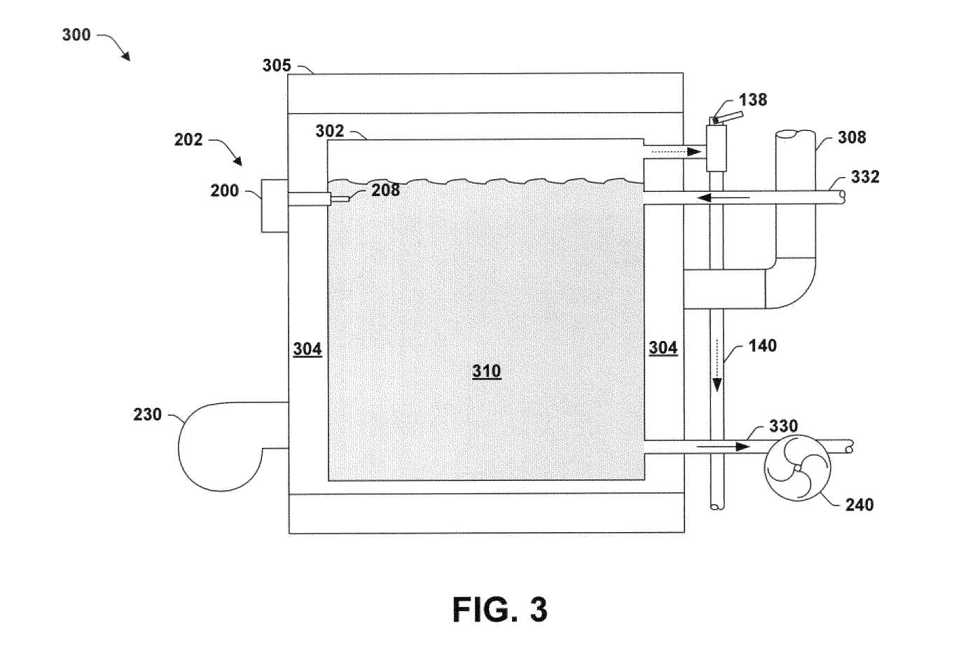

FIGS. 2A and 2B illustrate isometric diagrams of an exemplary boiler controller 200 and an exemplary multi-sensor component 208, for example, as is illustrated separately in FIG. 2C, together comprising one embodiment of a boiler control system 202 such as may be used in the boiler system (boiler) 300 of FIG. 3. The exemplary multi-sensor component 208 is also known herein as TPPS 208, to represent the temperature, pressure and presence sensor functions which this device may perform. The exemplary boiler controller 200 (e.g., hot water or steam boiler), may be used in accordance with one aspect of the present invention to monitor one or more of a temperature, a pressure and a presence of a medium in a boiler 300, and further operable to control a burner 230 and a circulation pump 240 associated with the boiler 300 similar to that of boiler control system 202 of FIGS. 2D and 3, illustrated and described further hereafter.

Boiler controller 200 of FIGS. 2A and 2B further comprises a controller housing or case 204 for protection of the controller 200 and a user interface comprising a display 206 configured, for example, to display alphanumeric characters, representing one or more temperature and pressure measurements, and temperature set points associated with the boiler 300. Boiler controller 200 further comprises a thermostat input port 207 for connection to a thermostat located in a heated zone associated with the boiler 300. The exemplary boiler controller 200 also has a communications or bus port 205, such as a 4 wire serial bus port to digitally communicate with one or more or a combination of wired and wireless accessory modules, an RF transceiver, a router, a remote display, a low-water cut-off alarm, a lockout alarm, an outdoor temperature sensor, a fuel tank level sensor, a POTs modem, a zone temperature sensor, and a thermostat.

As can also be seen in FIG. 2C, the exemplary multi-sensor component 208, for example, may be threaded into the boiler tank (e.g., 302 of boiler 300 of FIG. 3), while the boiler controller 200 may be mounted onto sensor TPPS 208, and the case 204 of boiler controller 200 secured to the exterior of the boiler enclosure (e.g., 305 of boiler 300 of FIG. 3). In this way, TPPS 208 is adapted to make direct contact with the medium (e.g., medium 310, water, water-glycol mix within the boiler 300). TPPS 208, for example, may then utilize a modular plug to electrically interconnect the sensor/detector functions into the boiler controller 200 as shown in FIG. 2D.

FIG. 2D further illustrates a simplified diagram of an exemplary boiler control system 202 comprising a boiler controller 200 such as that of the boiler controller 200 of FIGS. 2A-2B used in accordance with an aspect of the present invention. The boiler controller 200 comprises a sensor monitor or sensor monitoring component 203 for monitoring or measuring various sensor/detector inputs. For example, the monitoring component 203 of boiler controller 200 may be coupled to sensor TPPS 208, which may include a temperature detector and a pressure detector, and optionally a presence detector, and is operable to communicate a TPPS signal 209 to the monitoring component 203 of boiler controller 200. The sensor monitoring component 203 of boiler controller 200 may also be coupled to a thermostat or temperature sensor 206 operable to communicate a temperature signal 207 to the monitoring component 203 of boiler controller 200, and an outdoor air temperature sensor OAT 210 operable to communicate an outdoor air temperature signal OAT signal 211 to the monitoring component 203 of boiler controller 200. The monitoring component 203 of boiler controller 200 may also be coupled to a fuel tank level sensor 214 located within a fuel tank 212, and operable to communicate a tank level signal 215 to the monitoring component 203 of boiler controller 200.

Boiler controller 200 of boiler control system 202 of FIG. 2D further comprises a burner controller 220 adapted to communicate sensor data 221 with the sensor monitoring component 203. Burner controller 220 is further configured to provide one or more control signals to burner 230 by a control line 231, and is operable to activate the burner 230 to heat the boiler 300, for example, by burning a fuel 213 supplied from fuel tank 212.

The burner controller 220 is further operable to control the burner 230 to heat the boiler based upon the sensor data 221 communicated from the sensor monitoring component 203 of boiler controller 200. In particular, the burner 230 may be controlled or activated, for example, based upon: the temperature of the medium 310 as measured by the temperature detector 208 as compared to a range of temperature setpoints, energy efficiency calculations based on data (e.g., 221 and 209) from the temperature of the medium 310 and a system duty cycle, a presence of the medium 310, or a pressure of the medium 310. The burner controller 220 is further configured to disable the burner 230 and issue an overpressure alarm when an overpressure condition within the boiler 300 is detected using the pressure measured by, for example, sensor TPPS 208 or a separate pressure detector (e.g., 125/126).

In one embodiment, the one or more control signals provided by the burner controller 220 on control line 231 may be operable to modulate or otherwise adjust a flame of the burner 230, for example, to obtain a desired boiler medium temperature. That is, the flame may be throttled up and down or may be turned on and off to achieve the desired boiler medium temperature, and all such flame or burner control variations are anticipated herein.

In one embodiment, the boiler controller 200 may further comprise an economizer algorithm 250 or fuel saving algorithm 250 to assist the burner controller 220 in the control of the burner 230 to heat the boiler 300. For example, the economizer algorithm 250, in addition to utilizing the sensor data 221, may compute the most energy efficient set-point temperature for the boiler 300 based on one or more of a duty cycle of the thermostat and/or the boiler temperature thermal decay rate (boiler time constant, boiler TC or system duty cycle), the outdoor air temperature signal OAT 211, and/or a zone air temperature or a hot water heater temperature.

Generally, the economizer algorithm 250 will seek to find the lowest practical boiler temperature which still permits the thermostats to be satisfied, or it may also seek to achieve a 50% system duty cycle. Often, when a boiler is properly sized, the 50% system duty cycle achieves a good balance of typical losses and gains in the boiler system. For example, the energy efficiency calculations may seek to minimize such losses as stack losses due to heat carried up the chimney, pre-purge losses incurred while flushing air/fumes/gasses from the combustion chamber before fuel ignition, or to lower the variation or change in the regulated zone temperature (delta-T). Thus, in one embodiment, the boiler controller saves energy/fuel by seeking the lowest boiler set-point temperature and eliminates the need for additional and relatively costly medium presence detection (e.g., low-water cutoff) devices and controls (e.g., related relays, power supplies, and microprocessors) currently used in conventional boiler/HVAC systems (e.g., boiler 100 of FIG. 1).

The boiler controller 200 of the boiler control system 202 may further comprise a power input 270 such as a 120 VAC or 24 VDC power input. The boiler controller 200 is configured to measure the line voltage from the power input 270, and to control a shut-down of the burner (to a standby condition), for example, if the 120 VAC line voltage drops below 72V for 5 seconds, or drops below 78V for 20 seconds.

The boiler controller 200 of the boiler control system 202 may also include a zone control ZC 272 output for controlling zone system relays/valves, and a zone return ZR 274 input from the zone system. ZC 272 is energized if the medium temperature is above the low limit and allows a zone to recognize a call for heat (CFH). ZR 274 is energized from a zone that has a ZC signal and a call for heat.

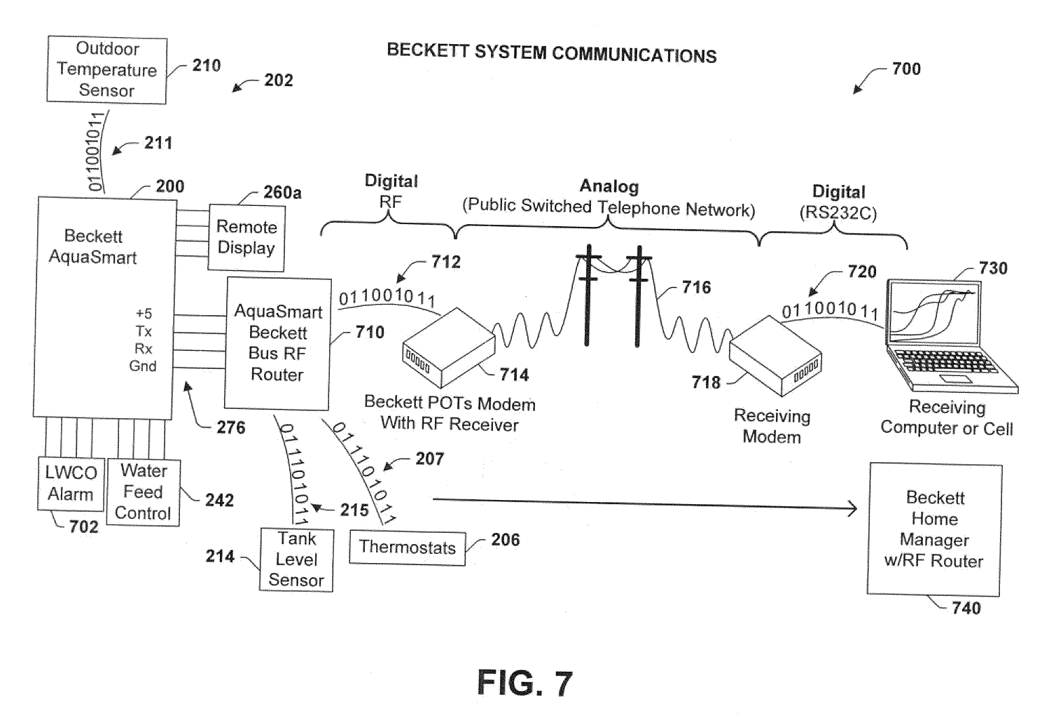

The boiler controller 200 of the boiler control system 202, may further include an accessory port 276, for example, comprising a 4-wire serial bus coupled to a variety of accessory modules 277 such as an RF transceiver, a router (e.g., 710 of FIG. 7), a remote display (e.g., 260a of FIG. 7), a low-water cut-off alarm (e.g., 702 of FIG. 7), an outdoor temperature sensor 210, a fuel tank level sensor 214, a POTs modem (e.g., 714 of FIG. 7), a zone temperature sensor, and a thermostat 210.

For example, the RF transceiver accessory module 277 may be used for wirelessly communicating and/or with one or more or a combination of a zone air temperature located within the zone heated by the boiler 300, the zone air temperature operable to provide a temperature indication associated with the heated zone, a hot water heater temperature associated with a hot water heater, and a thermostat (e.g., 206) located within the zone heated by the boiler 300, the thermostat operable to provide a temperature indication associated with the heated zone. The RF transceiver accessory module 277 may also be used for wirelessly communicating with an outdoor temperature detector (e.g., 210) operable to measure an outdoor air temperature associated with the boiler 300, and a tank level detector 214 operable to measure a fuel level of a fuel 213 in a fuel tank 212 associated with the boiler 300. It will be appreciated that such communications between the boiler controller 200 and any of the accessory modules 277 may also be digitally communicated either by wired or wireless means.

The boiler controller 200 of the boiler control system 202 is also adapted to be coupled by way of a control line 241 to a circulation pump 240 for circulating the heated medium 310 via feedwater line (e.g., 330 of FIG. 3) to a zone heated by the boiler 300, and for returning the cooled water via supply/return line 332 back to the boiler 300. Control line 241 may be used to energize the circulation pump 240, or may also be used to communicate a pump failure indication from the circulation pump 240 back to the boiler controller 200.

The boiler controller 200 of the boiler control system 202 is also adapted to be coupled to a user interface 260 by way of a user interface bus 261. The user interface 260 is affixed on or within the boiler controller case 204 for housing and protection of the user interface 260. The user interface 260 comprises a display 206 configured to display alphanumeric characters, for example, representing one or more temperature and pressure measurements, and temperature set points associated with the boiler. The user interface 260 also comprises a plurality of pushbuttons 266 for inputting and changing the set points, for selecting one or more operational modes of the boiler controller 200, and for configuring one or more options of the boiler controller 200.

The boiler controller 200 is also configured and operable to receive one or more initial parametric inputs 280 provided by the manufacturer. For example, these initial parametric inputs 280 may include one or more of a low limit and high limit temperature setpoint, a low limit and high limit temperature differential, a low limit and high limit pressure setpoint, a circulation pump exercise time, a circulation pump inactivity time, a circulation pump off delay time, a circulation pump on delay time, a line voltage minimum and maximum, a boiler set-point temperature, a sensor and controller model number, a sensor and controller serial number, a manufacturing date, a calibration temperature and a calibration pressure.

The boiler controller 200 of the boiler control system 202 comprises control circuitry and an algorithm 250, for example, provided on a PCB, configured and operable to monitor, using the sensor monitor 203, various temperature, pressure, and medium presence signals 209 from TPPS 208, outdoor air temperature signal 211 from OAT 210, a temperature setting signal 207 from thermostat 206, and a tank level signal 215 from tank level sensor 214, for example, in order to achieve sensor data 221. The boiler controller 200 is then configured and operable to use the sensor data 221 from the sensor monitor 203, the set points entered by the user interface 260, and/or data from the accessory modules 277, and/or the initial parameter inputs 280, for example, in the economizer algorithm 250 to reestablish a minimal boiler temperature set point which will provide improved energy efficiency, reduced losses and/or lower zone temperature changes. In response, the burner controller 220 of the boiler controller 200 regulates the on-time of the burner 230 to achieve the calculated temperature, and energizes the circulation pump 240 to circulate the medium throughout the one or more zones.

FIG. 3 illustrates an exemplary boiler system 300 (e.g., hot water or steam boiler), utilizing a single boiler controller 200 and an associated multi-sensor component (e.g., TPPS 208) for controlling the boiler system 300 in a fail-safe manner in accordance with the present invention. Other such boiler systems, hot water heaters, hot water or steam boilers, and HVAC systems may also incorporate the boiler controller 200 of the present invention to help regulate various operational aspects of the system.

The exemplary boiler 300 of FIG. 3 comprises a boiler tank 302 surrounded by an insulating material layer 304 within a boiler enclosure 305. A burner 230, having a flue vent 308, heats water 310 within the tank 302 to a temperature set by one or more temperature, pressure and presence sensing devices (e.g., TPPS 208). The heated water 310 is circulated, by way of a circulation pump 240, through a feed water line 330 to an external heat exchanger (not shown) in a zone associated with the boiler 300, and the cooled water returns to the boiler 300 through a supply/return line 332. If the level of the water 310 within the boiler tank 302 drops below the level of the level or presence sensing device, the burner 306 is shut-down until additional water 310 is added to the boiler 300 to maintain safe operation and avoid boiler damage.

The boiler 300 may further comprise the water pressure sensor (e.g., TPPS 208) may then use the detected pressure, to safely control a shut-down of the boiler in the event of an over-pressure condition, and to avoid dumping water through a pressure relief valve 138 and discharge line 140 onto the floor of the boiler room. In addition, the boiler controller 200 is configured to be disabled or to disable the burner 230 and issue an overpressure alarm when an overpressure condition within the boiler 300 is detected using the pressure measured by, for example, sensor TPPS 208 or a separate pressure detector (e.g., 125/126).

Thus, the boiler controller 200 is used to regulate and control the temperature, pressure and level of a medium (e.g., water, water-glycol mix, Freon, ammonia, or alcohol) used in the boiler system 300, hot water or steam boiler, hot water heater, or another such HVAC system, and control the functions provided together in a single boiler controller 200 for the boiler control system 202.

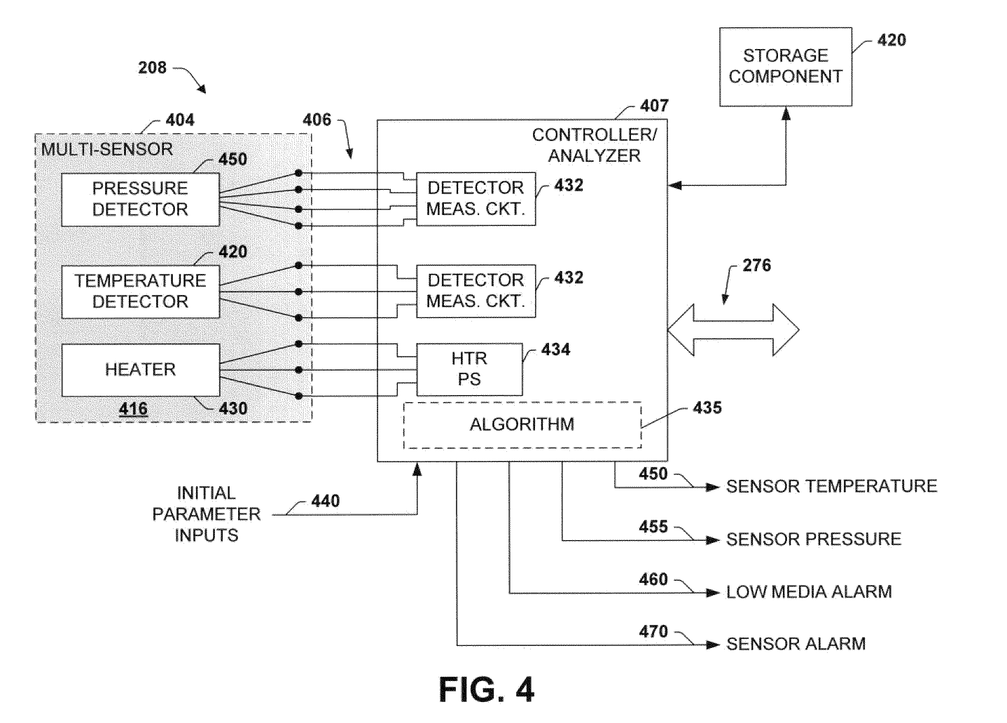

FIG. 4 illustrates an equivalent circuit of an exemplary temperature, pressure and presence sensing device or multi-sensor component (e.g., TPPS 208) such as may be used in the boiler control system 202 and in association with the boiler controller 200 of FIGS. 2A-2D and 3 for monitoring the temperature, pressure and presence of an object or medium 310, in accordance with an aspect of the present invention.

Sensor 208 of FIG. 4 comprises a temperature detector 420, a heater 430 and a pressure detector 410. In one embodiment, the sensor 208 of FIG. 4 further comprises the temperature detector 420 and/or the pressure detector 410, and the heater 430 affixed together within a single casting or potting material 416 (e.g., silicon rubber, thermal epoxy, or ceramic material) to provide a close thermal union between the two elements. In another embodiment, the temperature detector 420 and/or the pressure detector 410, and the heater 430 may be, for example, affixed, bonded, deposited, or glued together onto a dry side of a substrate (not shown) opposite from a wet side of the substrate in contact with the medium (e.g., 310).

The TPPS sensor 208, for example, further comprises a controller/analyzer 407 that is operable to monitor the resistance measurements of the temperature detector 420 or the heater 430, respectively, and provide associated temperatures. In one embodiment, the controller/analyzer 407 of FIG. 4 is also operable to measure a differential strain gauge based pressure signal from the pressure detector 410 and provide a pressure of the medium 310 within the boiler 300, for example, using a detector measuring circuit 432. Then, using the resistance measurements or the temperatures, the analyzer is further operable to compute the thermal decay rate time constant (TC) of the sensor 208 to determine whether a medium (or object) is present at (or an object is in contact with) the sensor 208. Further, the health of the sensor 208 may also be ascertained with the assistance of the controller/analyzer 407 (e.g., microprocessor, PIC, microcomputer, computer, PLC), by monitoring the temperature detector 420 or the heater 430, and comparing the temperature indicated to the temperature of the heater 430 after thermal equilibrium is established at the expected regulation temperature.

For example, sensor 208 of FIG. 4 comprises a fail-safe sensor 208 connected to a controller/analyzer 407 (e.g., microprocessor, PIC, microcomputer, computer, PLC). The controller/analyzer 407 is further operably coupled to a storage component 420 (e.g., memory) for storage of initial input parameters 440 (e.g., initial resistance of the detector at a certain temperature, expected regulation temperature, low medium alarm levels or acceptable TC levels for the presence of an object or medium, acceptable sensor degradation levels, etc.). Controller/analyzer 407 further comprises a detector measurement circuit 432 for monitoring the temperature of the temperature detector 420 of sensor 208 or optionally the heater 430 (acting as the temperature detector) of sensor 208. Controller/analyzer 407 also comprises a detector measurement circuit 432 for monitoring the pressure of the pressure detector 410 of sensor 208. Controller/analyzer 407 also includes a controllable heater power supply 434 (e.g., 5 VDC, 120 VAC) to supply a voltage or current to the heater 430 (e.g., resistance wire, thermistor, integrated circuit heater) for heating the sensor 208 to an expected temperature.

Controller/analyzer 407 further comprises an algorithm 435 (e.g., a program, a computer readable media, a hardware state machine) that is applied to the respective system to calculate and analyze the temperature monitoring, pressure, presence detection, and/or sensor degradation and failure prediction. Upon completion of such calculations and/or analysis, the algorithm 435 provides several possible output results from the controller/analyzer 407 that may include a present sensor temperature 450 (e.g., 180° F.), a sensor pressure/sensor overpressure 455 (e.g., 200 PSI), and if a predetermined limit has been achieved, a low medium alarm 460 (e.g., low-water cut-off level, medium absent), and/or a sensor alarm 470 (e.g., sensor or system failure imminent, sensor maintenance required) may be issued. In addition, controller/analyzer 407 is also configured and operable to communicate with an input/output bus 276 such as a 4-wire digital bus to supply the above outputs and/or to receive the initial parameter inputs 440.

Alternately, in addition to the temperature detector 420 measurements, the current and voltage going into the heaters 430 of sensor 208 may be monitored and the resistance calculated during the heating phase to provide continuous temperature monitoring based on the resistance calculation.

In another embodiment of the present invention, the multi-sensor component or TPPS sensor 208 may comprise an integrated circuit heater and/or detector further operable, for example, to digitally communicate to the controller/analyzer 407 a temperature signal, a pressure, a sensor parametric input, a sensor model, a sensor serial number, a manufacturing date, and a calibration temperature, for example.

In yet another embodiment, the multi-sensor component or TPPS sensor 208 may comprise individual detectors such as those of FIG. 1.

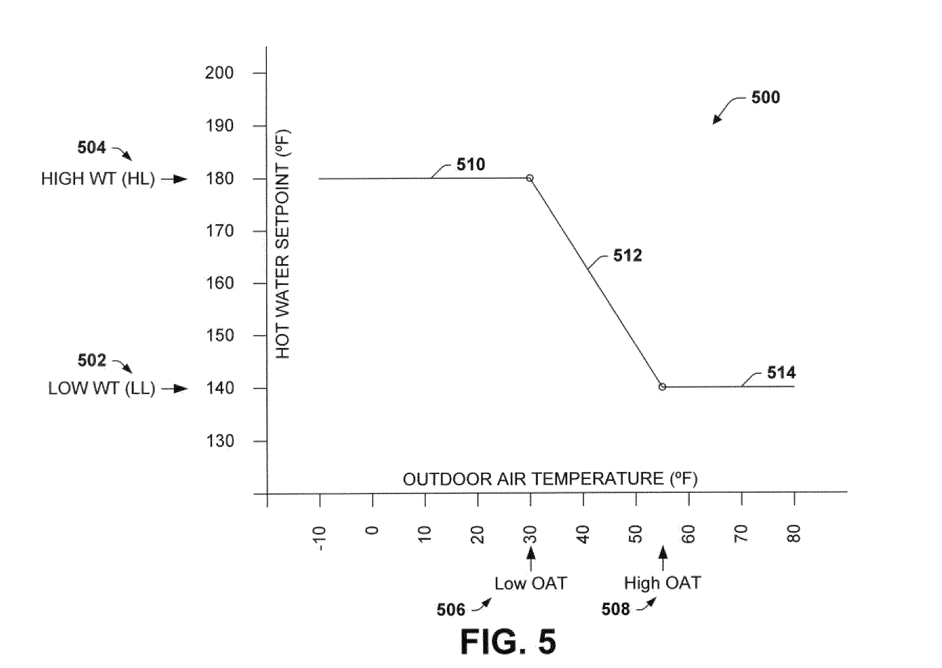

FIG. 5 illustrates a simplified plot 500 of exemplary hot water temperature setpoints 502/504 vs. exemplary outdoor air temperatures 506/508 for an exemplary outdoor air temperature sensor (e.g., OAT 210), such as may be used to establish temperature setpoints for the boiler controller 200 of FIGS. 2A, 2B, 2D and 3 in accordance with another aspect of the present invention. FIG. 5 illustrates, for example, a low boiler water temperature (Low WT 502) or low limit temperature (LL 502) set at a setpoint of 140° F. for outdoor air temperatures above a high outdoor air temperature setpoint (High OAT 508) of 55° F., and a high boiler water temperature (High WT 504) or high limit temperature (HL 504) set at a setpoint of 180° F. for outdoor air temperatures below a low outdoor air temperature setpoint (Low OAT 506) of 30° F. Thus, three ranges are created; a water setpoint range 510 for low outside air temperatures below 30° F. (Low OAT 506), a water setpoint range 514 for high outside air temperature above 55° F. (High OAT 508), and a boiler water setpoint range 512 between 30° F. (Low OAT 506) and 55° F. (High OAT 508). One or more other boiler water temperature setpoints, outdoor air temperatures setpoints and ranges may be used and are also contemplated.

In one embodiment, the low limit temperature (LL 502) comprises the temperature above which the boiler turns off if there is not a heat demand. The boiler will not fire again, unless there is a heat demand until the boiler water temperature drops below the low limit less a low limit differential.

In another embodiment, the high limit temperature (HL 504) comprises the temperature above which the boiler controller will cease to fire the boiler if there is a heat demand. The boiler will not fire again, until the boiler water temperature drops below the high limit less a high limit differential.

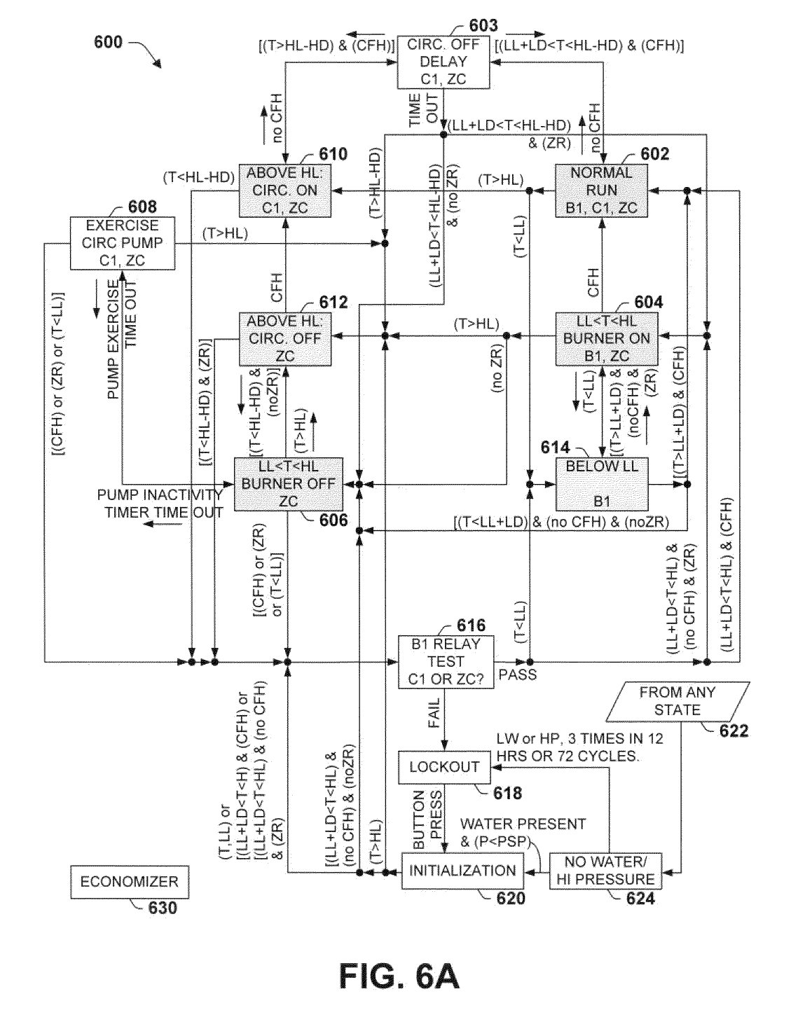

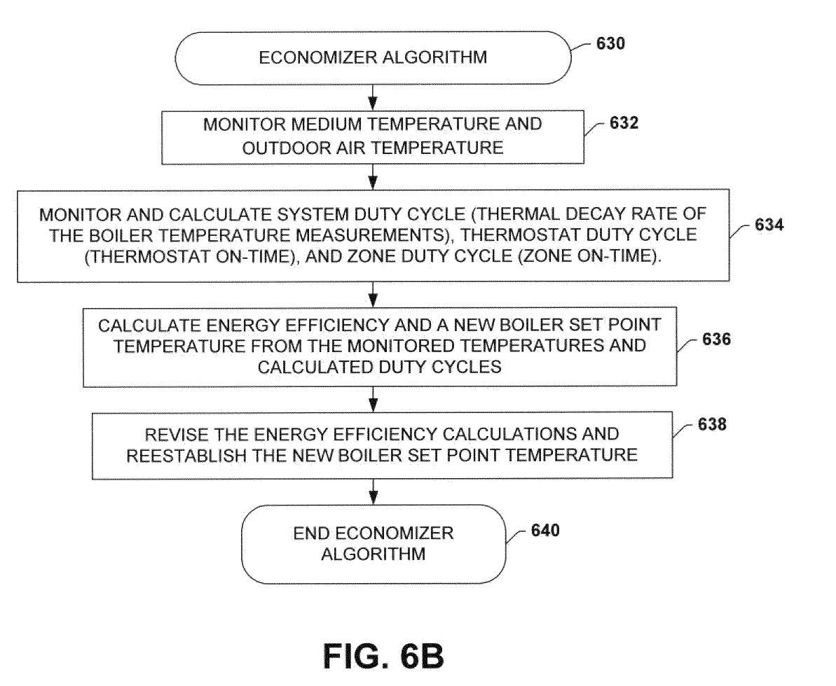

FIG. 6A illustrates an exemplary functional state diagram of a control algorithm 600 for an exemplary boiler control system such as the boiler control system 202 of FIGS. 2D and 3 in accordance with an aspect of the present invention. The control algorithm 600 for the boiler controller (e.g., 200) provides a means of monitoring, analyzing and controlling the temperature, pressure and presence of a medium (e.g., 310) within a boiler (e.g., 300), for controlling the burner (e.g., 230) and circulation pump (e.g., 240) of a boiler system (e.g., 300), for testing controller components (e.g., 208, 230, 240) or monitoring for system failures, and for monitoring and calculating energy efficiencies, all in a fail-safe manner.

For example, the control algorithm 600 of FIG. 6A indicates at 610 and 612 the functional or control states which exist when the boiler water temperature is above the high limit setpoint (HL), while 614 indicates the functional or control states which exist when the boiler water temperature is below the low limit setpoint (LL), and 602, 604 and 606 all indicate the functional or control states which exist when the boiler water temperature (T) is between the low limit setpoint (LL) and the high limit setpoint (HL) or (LL<T<HL).

In the control algorithm 600, the letter designations that appear within the state blocks indicate the active or energized controls and terminal of the boiler controller 200. For example, B1 indicates the burner (e.g., 230) is energized, C1 indicates the circulation pump (e.g., 240) is energized, ZC indicates the zone control terminal (e.g., 272 of FIG. 2D) is active or energized, and ZR indicates the zone return terminal (e.g., 274 of FIG. 2D) is active or energized. Additionally, an arrow entering a state block indicates an input condition, while an arrow leaving the state block indicates the creation of a new condition which is being passed on to one or more other state blocks.

As a further example, state block 603 represents the control states for a “circulation pump off delay timer”, which disables the circulator after the delay time when there is no call for heat (no CFH) (e.g., see arrows entering state block 603). State block 608 represents the control states for a timer that exercises the circulation pump when a pump inactivity timer has timed out, and state block 616 represents the many control states that will initiate a burner (B1) relay test.

In one embodiment, the burner (e.g., 230) is driven and controlled by one or more burner relays, wherein one or more of the relays has at least one contact that provides a relay feedback check to the burner controller (e.g., 220), in order to permit verification of the relay's connection or lack of connection to the burner (e.g., 230). Thus, the burner controller (e.g., 220) is configured to provide a fail-safe connection to the burner (e.g., 230).

If the burner (B1) relay test in state block 616 passes OK (see arrow leaving block 616 to the right side), the state diagram controls continue as described above normally. However, if the burner (B1) relay test in state block 616 fails (see arrow leaving block 616 to the right side), control then passes to lockout block 618 where all outputs are turned off until a power reset is initiated by the user pressing a button (see arrow leaving block 618 downward). When the user does press a button to indicate a power reset at lockout block 618, an initialization of the system commences at initialization block 620, wherein steps are taken upon power-up and after the conditions indicated above to initialize the a microprocessor utilized in the boiler controller 200. Thereafter, the state diagram controls continue as described above normally as shown by the arrows leaving initialization block 620 to the left.

At the same time as the above, additional checks are continually made from any of the states above, as indicated by state block 622, wherein checks on the presence and pressure of the water are made at state block 624. If it is determined at state block 624 that no water is present (low water, LW) at the medium presence detector (e.g., using detector 208), or a high pressure (HP) is detected (e.g., using detector 208), and continued monitoring reveals that these conditions have occurred, for example, 3 times in 12 hours or for 72 heating cycles, or for a predetermined number of times within a predetermined time interval, or for a predetermined number of heating cycles, then the lockout condition will remain at lockout block 618 until a button is pressed again. If, however, it is determined at state block 624 that the medium (e.g., water) is present and that the pressure (P) is below some normal or preset pressure (P<PSP), then initialization of the system commences at initialization block 620 and the state diagram controls continue as described above normally.

In addition to the continual water pressure and presence checking at 622 and 624, an economizer algorithm 630 or another such fuel saving algorithm or energy calculation routine, such as economizer algorithm 250 of FIG. 2D described above, is continually performed on the exemplary boiler control system (e.g., boiler control system 202 of FIGS. 2D and 3), in accordance with another aspect of the present invention. As described above, the economizer or fuel saving algorithm 250 assists the burner controller 220 in the control of the burner 230 to heat the boiler 300. For example, the economizer algorithm 250, in addition to utilizing the sensor data 221, may compute the most energy efficient set-point temperature for the boiler 300 based on one or more of a duty cycle of the thermostat and/or the boiler temperature thermal decay rate (boiler time constant, boiler TC or system duty cycle), the outdoor air temperature signal OAT 211, and/or a zone air temperature or a hot water heater temperature.

In one embodiment, the economizer or fuel saving algorithm 630 limits the cycling of the attached burner 230 and circulator(s) 240 based on data from the attached temperature sensor 208.

FIG. 6B illustrates a flow diagram of a method 630 of economizing utilizing an economizer algorithm, such as economizer or fuel savings algorithm 250 of FIG. 2D, for example, in the boiler system 300 of FIG. 3, comprising monitoring the medium 310 and outdoor air temperatures 210 and calculating a lowest practical boiler set-point temperature that will allow the boiler 300 to meet a range of setpoints and/or the thermostat 206 and zone temperature setpoints in accordance with one or more aspects of the present invention.

While the method 630 is illustrated and described below as a series of acts or events, it will be appreciated that the present invention is not limited by the illustrated ordering of such acts or events. For example, some acts may occur in different orders and/or concurrently with other acts or events apart from those illustrated and/or described herein, in accordance with the invention. In addition, not all illustrated steps may be required to implement a methodology in accordance with the present invention. Furthermore, the method 630 according to the present invention may be implemented in association with the boiler control system, the boiler system, and the temperature, pressure and presence detection systems, elements, and devices illustrated and described herein as well as in association with other systems, elements, and devices not illustrated.

The present invention provides an exemplary method 630 of controlling a hot water or steam boiler (e.g., 300) to regulate a temperature within the boiler and in a zone heated by the boiler, and to limit a pressure and maintain a presence of a medium (e.g., 310) within the boiler (e.g., 300) using a boiler controller (e.g., 200). The boiler controller (e.g., 200) comprises a sensor monitor (e.g., 203) coupled to a temperature detector (e.g., 208) operable to measure a temperature of the medium (e.g., 310) within the boiler (e.g., 300), and a pressure detector (e.g., 208) operable to measure a pressure of the medium (e.g., 310), a circulation pump (e.g., 240) operable to distribute the medium (e.g., 310) within the heated zone, and a burner controller (e.g., 220) operable to control a burner (e.g., 230) to heat the boiler (e.g., 300).

In one embodiment, the exemplary economizer algorithm or method 630 of FIG. 6B begins at 632, wherein the temperature of the medium (e.g., 310) within the boiler (e.g., 300) is monitored and measured, for example, utilizing the temperature/pressure/presence detector (e.g., TPPS 208), and also wherein an outdoor temperature detector (e.g., 210) is monitored and measured to provide an outdoor air temperature (OAT) associated with the boiler (e.g., 300).

At 634, the method 630 monitors and calculates the system duty cycle (e.g., the thermal decay rate of the boiler temperature measurements, via TPPS 208 after a heating cycle), the thermostat duty cycle (the thermostat on-time vs. off-time), or the zone duty cycle (the zone on-time vs. off-time).

At 636 of method 630, the energy efficiency of the boiler system (e.g., 300) and a new boiler set point temperature is calculated based on the measured temperatures and one or more of the calculated duty cycles. For example, the algorithm may be used to calculate and identify a lowest possible set-point temperature for the boiler to minimize thermal loses from the boiler and various system components and piping, as well as heat lost up the flue and pre-purge losses, etc.

At 638, the method 630 revises the energy efficiency calculations which are used to set the boiler set-point temperature, and accordingly reestablishes the boiler set-point temperature.

At 640, the economizer algorithm or method 630 ends, wherein the algorithm may be recalculated based upon updated data and measurements.

Another exemplary embodiment of the economizer algorithm method, such as is illustrated in the method 600 of FIG. 6A, using the exemplary boiler control system 202 of FIG. 2D, comprises monitoring and measuring the temperature of a medium (e.g., 310) within a boiler (e.g., 300), for example, utilizing a temperature detector (e.g., 208), determining whether to activate or otherwise controlling a burner (e.g., 230) to heat the boiler, and heating with the burner (e.g., 230) until the temperature of the medium within the boiler is above a high limit temperature setpoint (e.g., T>HL of FIG. 6A, and HL 504 of FIG. 5), and circulating the heated medium through the zone using a circulation pump (e.g., 240) if the zone issues a call for heat (e.g., CFH of FIG. 6A) to a boiler controller (e.g., 200).

The method further comprises heating the boiler (e.g., 300) with the burner (e.g., 230) until the zone stops calling for heat from the boiler controller (e.g., 200), circulating the heated medium (e.g., 310) through the zone using the circulation pump (e.g., 240) if a pump inactivity timer (e.g., arrow from 606 of FIG. 6A) expires in the boiler controller (e.g., 200), circulating the heated medium (e.g., 310) until a pump exercise timer times out (e.g., arrow from 608 of FIG. 6A), and circulating the heated medium through the zone using the circulation pump (e.g., 240) until the zone stops calling for heat from the boiler controller and a circulator off-delay timer (e.g., 603 of FIG. 6A) times out. The method also comprises energizing a zone control terminal (e.g., 272 of FIG. 2D) of the boiler controller if the temperature of the medium within the boiler is above a low limit temperature setpoint (e.g., T>LL of FIG. 6A, arrow entering 602 and 604 of FIG. 6A, and LL 502 of FIG. 5), and measuring the pressure of the medium within the boiler and determining whether a high pressure condition exists (e.g., P<PSP?, 624 of FIG. 6A).

In one or more embodiments, the boiler control system 202 is operable to receive a user input, for example, from the user interface 260, to input a LWCO delay time, a high limit HL temperature setting (e.g., 504) and a low limit LL temperature setting (e.g., 502) within a predetermined allowable range such as 130 to 240° F., a pressure limit set point PSP (e.g., P>PSP, see 624 of FIG. 6A) within a predetermined allowable range such as 5-100 PSI and below a pressure relieve valve (e.g., 138 of FIG. 3) pressure setting, high and low limit differential temperatures within a predetermined allowable range such as 10° to 30° F., a circulator delay on time (e.g., 0-2 minutes), a circulator delay off time (e.g., 0-5 minutes), an outdoor temperature reset (OTR) High outside temperature (e.g., 40° to 70° F.), an outdoor temperature reset (OTR) Low outside temperature (e.g., 20° to 40° F.). Other user input settings and values are also contemplated within the scope of the present invention. It will also be appreciated that the boiler controller (e.g., 200) is further configured to provide a nominal factory default setting value within the allowable ranges for each of the above user inputs for the user who chooses not to enter a setting value.

FIG. 7 illustrates a simplified diagram of an exemplary Beckett communications system 700, such as may be used with the boiler controller of FIGS. 2A, 2B and 2D in accordance with one or more aspects.

For example, the a boiler control system 202 of the exemplary communications system 700, comprises a boiler controller (Beckett AquaSmart controller) 200, configured to monitor the temperature, pressure and presence of a medium, for example, using a TPPS sensor 208, to either wired or wirelessly monitor an outdoor air temperature sensor OAT 210, to either wired or wirelessly communicate with a remote operator display 260a, to monitor and control the burner 230 and the circulation pump 240, to monitor and control a water feed control (make-up water supply control) 242, and to provide a low water cut-off alarm (LWCO) 702 as an output to a user alarm system, for example.

In one embodiment, the low water cut-off alarm (LWCO) 702 comprises a device that acts to interrupt power to a burner (e.g., 230) when the presence of the medium or water (e.g., 310) in the boiler (e.g., 300) can no longer be detected. Typically, LWCO 702 may be mounted directly into the boiler at a low water level location, above which the water level is to be maintained.

The communications system 700 may further comprise a bus RF router 710 coupled by way of, for example, a 2 to 8 wire serial bus 276 to the boiler controller 200. The bus RF router 710 is configured to either wired or wirelessly communicate 207 with one or more thermostats 206 located within one or more heated zones, to either wired or wirelessly communicate 215 with a tank level sensor 214 located on a fuel tank (e.g., 212) associated with the boiler (e.g., 300), and to either wired or wirelessly communicate 712 with a POTs (plain old telephone) Modem 714 having an RF receiver. The POTs Modem 714 may be coupled with an analog (or digital) public switched telephone network 716, that is further coupled to a corresponding receiving modem 718 configured to digitally communicate 720 (e.g., via RS232C) with a receiving computer or cell phone 730, for example, at a remote location.

RF wireless communications (e.g., 207, 215 and 712) with the bus RF router 710 may also be communicated with a Beckett home manager 740 having an RF router and may comprise an application on a PC, and may be managed from a remote location by Beckett for monitoring the health of the heating system, the oil level within the fuel tank, thermostat settings, or alarm conditions, for example, by service men or the home owner.

Although the invention has been illustrated and described with respect to one or more implementations, equivalent alterations and modifications will occur to others skilled in the art upon the reading and understanding of this specification and the annexed drawings. In particular regard to the various functions performed by the above described components (assemblies, devices, circuits, systems, etc.), the terms (including a reference to a “means”) used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising.”

What is claimed is:

1. A boiler controller for a boiler, comprising:
a sensor monitoring component, adapted to be coupled to:
a temperature detector operable to measure and communicate a temperature of a medium within the boiler to the sensor monitoring component; and
a pressure detector operable to measure and communicate a pressure of the medium to the sensor monitoring component; and
a burner controller configured to provide one or more control signals to a burner, operable to control the burner to heat the boiler based upon at least one of:
the temperature of the medium measured by the temperature detector as compared to a range of temperature setpoints,
results of an energy efficiency calculation using data from the temperature of the medium or a system duty cycle,
a presence of the medium, and
the pressure of the medium.

2. The boiler controller of claim 1, wherein the burner controller is operable to control the burner by utilizing an economizer algorithm, wherein the economizer algorithm is configured and operable to:
evaluate the temperature of the medium measured by the temperature detector and compare the temperature measurements of the medium to a range of temperature setpoints,
calculate one or more of a system duty cycle of a thermostat on-time and a thermal decay rate of the boiler temperature measurements, and perform the energy efficiency calculation therefrom, the energy efficiency calculation used to reestablish a boiler set-point temperature.

3. The boiler controller of claim 2, wherein the economizer algorithm is further configured and operable to:
monitor an outdoor temperature detector operable to measure an outdoor air temperature associated with the boiler, and revise the energy efficiency calculation used to reestablish a boiler set-point temperature therefrom.

4. The boiler controller of claim 3, wherein the economizer algorithm is further configured and operable to:
monitor and evaluate one or more of a zone air temperature and a hot water heater temperature, and revise the energy efficiency calculation used to reestablish a boiler set-point temperature therefrom.

5. The boiler controller of claim 4, wherein the economizer algorithm is further configured and operable to find a lowest boiler set-point temperature that will allow the boiler to meet the range of temperature setpoints.

6. The boiler controller of claim 1, wherein the sensor monitoring component further comprises
a presence detector operable to detect the presence of the medium, the presence detector located at a low medium level position of the boiler.

7. The boiler controller of claim 1, wherein the sensor monitoring component further comprises
an outdoor temperature detector operable to measure an outdoor air temperature associated with the boiler.

8. The boiler controller of claim 1, wherein the sensor monitoring component further comprises
a tank level detector operable to measure a fuel level of a fuel in a fuel tank associated with a burner used with the boiler.

9. The boiler controller of claim 1, wherein the burner controller is configured to disable the burner when an overpressure of the boiler is detected using the pressure measured by the pressure detector.

10. The boiler controller of claim 1, wherein the boiler controller further comprises an RF transceiver for wirelessly communicating with one or more or a combination of
a zone air temperature located within a zone heated by the boiler, the zone air temperature operable to provide a temperature indication associated with the heated zone,
a hot water heater temperature associated with a hot water heater,
a thermostat located within the zone heated by the boiler, the thermostat operable to provide a temperature indication associated with the heated zone,
an outdoor temperature detector operable to measure an outdoor air temperature associated with the boiler, and
a tank level detector operable to measure a fuel level of a fuel in a fuel tank associated with the boiler.

11. The boiler controller of claim 1, wherein the boiler controller further comprises a user interface comprising
a display configured to display alphanumeric characters, representing one or more temperature and pressure measurements, and temperature set points associated with the boiler, and
a plurality of pushbuttons for inputting and changing the set points, for selecting one or more operational modes of the boiler controller, and for configuring one or more options of the boiler controller.

12. The boiler controller of claim 1, wherein the one or more control signals provided by the burner controller are operable to modulate a flame of the burner to obtain the temperature of the medium.

13. The boiler controller of claim 6, wherein the temperature detector, the presence detector and the pressure detector are pre-fabricated together within a single multi-sensor component.

14. The boiler controller of claim 1, wherein the boiler controller is configured and operable to receive one or more initial parametric inputs provided by the manufacturer.

15. The boiler controller of claim 14, wherein the one or more initial parametric inputs provided by the manufacturer comprises one or more of a low limit and high limit temperature setpoint, a low limit and high limit temperature differential, a low limit and high limit pressure setpoint, a circulation pump exercise time, a circulation pump inactivity time, a circulation pump off delay time, a circulation pump on delay time, a line voltage minimum and maximum, a boiler set-point temperature, a sensor and controller model number, a sensor and controller serial number, a manufacturing date, a calibration temperature and a calibration pressure.

16. The boiler controller of claim 1, wherein the boiler controller is configured and operable to digitally communicate with one or more or a combination of wired and wireless accessory modules, an RF transceiver, a router, a remote display, a low-water cut-off alarm, a lockout alarm, an outdoor temperature sensor, a fuel tank level sensor, a POTs modem, a zone temperature sensor, and a thermostat.

17. The boiler controller of claim 6, wherein the boiler controller is configured to physically mount on a sensor housing of a sensor comprising one or more of the temperature detector, the presence detector and the pressure detector, and further comprising a modular plug for electrically interconnecting between the boiler controller and the sensor.

18. The boiler controller of claim 1, comprising one or more burner relays coupled between the burner controller and the burner,
wherein the boiler controller is configured to test at least one of the burner relays to insure that the burner can be energized and deenergized, and
wherein the boiler controller is operable to be disabled with a lockout condition if the burner relay test fails.

19. The boiler controller of claim 1, comprising a line voltage monitoring circuit,
wherein the boiler controller is configured to measure the line voltage with the line voltage monitoring circuit, and
wherein the boiler controller is operable to disable the burner if one of a line voltage minimum and maximum condition exists.

20. A boiler controller for a boiler, comprising:
a sensor monitoring component, adapted to be coupled to:
a pressure detector operable to measure a pressure of the medium;
a temperature detector operable to measure a temperature of a medium within the boiler; and
a presence detector operable to detect the presence of the medium; and one or more of:
an outdoor temperature detector operable to measure an outdoor air temperature associated with the boiler;
a tank level detector operable to measure a fuel tank level 25 associated with a burner used with the boiler; and
a thermostat located within a zone heated by the boiler, the thermostat operable to provide one of a temperature indication or a call for heat associated with the heated zone; and
a burner controller configured to provide one or more control signals to a burner, and operable to control the burner to heat the boiler based upon at least one of:
the temperature of the medium measured by the temperature detector as compared to a range of temperature setpoints,
results of an energy efficiency calculation using data from one or more of the temperature of the medium, a system duty cycle, the outdoor air temperature and the thermostat temperature indication, and
at least one of the presence of the medium, the pressure of the medium, and the fuel tank level.

21. The boiler controller of claim 20, wherein the boiler controller further comprises an RF transceiver for wirelessly communicating with one or more or a combination of
a zone air temperature located within the zone heated by the boiler, the zone air temperature operable to provide a temperature indication associated with the heated zone,
a hot water heater temperature associated with a hot water heater,
a thermostat located within the zone heated by the boiler, the thermostat operable to provide a temperature indication associated with the heated zone,
an outdoor temperature detector operable to measure an outdoor air temperature associated with the boiler, and
a tank level detector operable to measure a fuel level of a fuel in a fuel tank associated with the boiler.

22. The boiler controller of claim 20, wherein the boiler controller further comprises a user interface comprising
a display configured to display alphanumeric characters, representing one or more temperature and pressure measurements, and temperature set points associated with the boiler, and
a plurality of pushbuttons for inputting and changing the set points, for selecting one or more operational modes of the boiler controller, and for configuring one or more options of the boiler controller.

23. A method of controlling a boiler to regulate a temperature within the boiler and in a zone heated by the boiler, to limit a pressure and maintain a presence of a medium within the boiler using a boiler controller, the method comprising:
receiving a temperature of the medium within the boiler;
determining whether to heat the boiler, and enabling a heat signal for heating the boiler until the temperature of the medium within the boiler is above a high limit temperature setpoint;
generating a circulation signal for circulating the heated medium through the zone if the zone issues a call for heat to the boiler controller;
enabling the heat signal for heating the boiler until the zone stops calling for heat from the boiler controller;
generating the circulation signal for circulating the heated medium through the zone if a pump inactivity timer expires in the boiler controller, and circulating the heated medium until a pump exercise timer times out;
generating the circulation signal for circulating the heated medium through the zone until the zone stops calling for heat from the boiler controller and a circulator off-delay timer times out;
energizing a zone if the temperature of the medium within the boiler is above a low limit temperature setpoint; and
receiving a pressure of the medium within the boiler and determining whether a high pressure condition exists.

24. The method of claim 23, further comprising
determining whether a low medium condition exists by determining if the medium is present within the boiler at a temperature detector; and
disabling the boiler controller with a lockout condition if it is determined that the low medium condition exists.

25. The method of claim 23, further comprising
receiving a pressure of the medium within the boiler and determining whether a high pressure condition exists; and
disabling the boiler controller with a lockout condition if it is determined that the high pressure condition exists.
